(19) United States
(12) Patent Application Publication
(10) Pub. No.: US 2003/0121435 A1
(43) Pub. Date: Jul. 3, 2003

(54) End sealing of the doctor blade chamber

(76) Inventors: Rainer Jendroska, Ladbergen (DE); Guido Averdiek, Georgsmarienhuette (DE)

Correspondence Address: JACOBSON HOLMAN PLLC, 400 SEVENTH STREET N.W., SUITE 600, WASHINGTON, DC, 20004, US

(21) Appl. No.: 10/270,356

(22) Filed: Oct. 15, 2002

(30) Foreign Application Priority Data
Oct. 16, 2001 (DE) 101 50 488.8

(51) Int. Cl. B41F 31/00

(52) U.S. Cl. 101/350.6

(57) ABSTRACT

An ink chamber (1) for rotation printing machines is shown, which is comprised of at least the following elements:

an ink roll (2) that rotates around an axis (D) during operation,

an elongated doctor blade chamber body (4) that limits the ink chamber (1) at least on the side opposite the ink roll (2),

at least one supply line, through which ink reaches the interior of the ink chamber,

two wedge-like doctor blades (23, 24) that can be set to the ink roll,

two sealing bodies (7) that limit the ends of the ink chamber (1), whereby the sealing surfaces of the sealing bodies are set against the ink roll (2),

two first intermediate walls (11), of which one each is arranged between the dye zone (14) of the ink roll and the respective sealing body so that first chambers (9) are created on each side of the doctor blade chamber between the sealing bodies (7) and the intermediate walls (11),

at least two bores (18) that discharge ink from the first chambers (9)

In addition, at least one additional intermediate wall (13) is provided between the dye zone (14) of the ink roll (2) and the first intermediate walls (11) so that at least one additional chamber (10) is created between the first (11) and the additional intermediate walls (13).

The invention relates to a doctor blade chamber for rotation printing machines according to the generic term of claim 1.

Such doctor blade chambers are used particularly in flexographic printing machines. For example, EP 0 822 897 B1 shows such a device. In doctor blade chambers of this known type, the end sealing poses a problem.

Therefore, the task of the invention at hand is to recommend a doctor blade chamber, in which the end sealing is improved.

The task is solved by the characteristic part of claim 1.

In the mentioned use of several intermediate walls, their penetration probabilities multiply so that less ink enters the first chamber than the second, which is located in closer proximity to the filled ink reservoir.

The use of the at least one intermediate wall in combination with shortened doctor blades has proven to be advantageous. This circumstance is due to the fact that in the operation of doctor blade chambers of prior art, ink or ink residue creep along the doctor blades, and directly reach the end seal of the doctor blade chamber in this way. The use of doctor blades that already end between an intermediate wall and the seal provides a remedy for this problem. The ink, or the ink residue then drips off the end of the doctor blades, and are accumulated in the chambers, and are discharged by means of bores, or lines, respectively. However, this measurement is possible only if the doctor blade chamber is not tilted toward the shortened doctor blade, because otherwise ink will run off between the end of the shortened doctor blade and the seal.

In this regard it is particularly advantageous that the locking doctor blade is embodied in the described manner. This circumstance is achieved in that the locking doctor blade scrapes off excess, partially dried on ink from the anilox roll. This ink residue is deposited on the exterior of the doctor blade. Especially this ink residue can substantially influence the function of the doctor blade end seals if it gets into the space between the seal and the roll. This possibility does not exist with the use of shortened locking doctor blades, as the ink residue reaches the first or second chamber, and is discharged from there through the bores, or lines, respectively, that are assigned to the respective chambers.

Doctor blade chambers according to the invention are suitable both in the use of an open (atmosphere pressure) and in the use of a closed (ink is under pressure, will possibly be pumped) ink feeding system.

Additional advantageous embodiments and embodiment examples of the invention are found in the additional claims, the subject description, and the drawings.

The individual figures show:

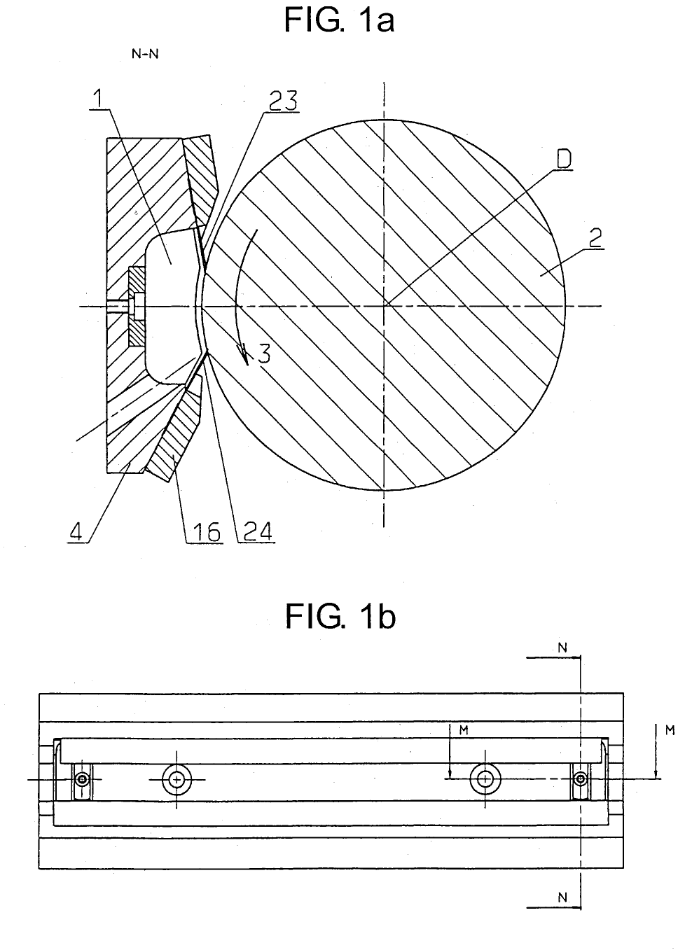

FIG. 1a A section through a doctor blade chamber along the line N-N

FIG. 1b A top view of the doctor blade chamber, whereby the anilox roll is disavowed from the doctor blade chamber body

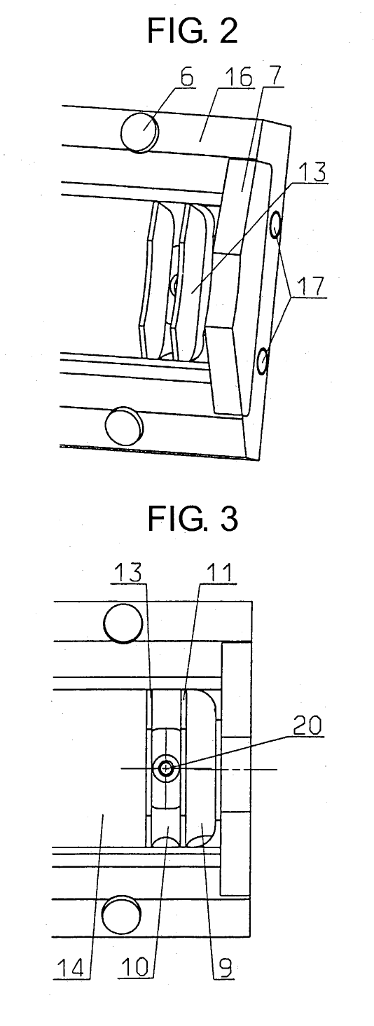

FIG. 2 An isometric view of the doctor blade chamber with a disavowed anilox roll, whereby only the elements in the proximity of the end of the doctor blade chamber are shown, and whereby the doctor blades and their support rails are not illustrated

FIG. 3 A top view of the elements of the doctor blade chamber shown in FIG. 2, whereby the doctor blades and their support rails are also not illustrated

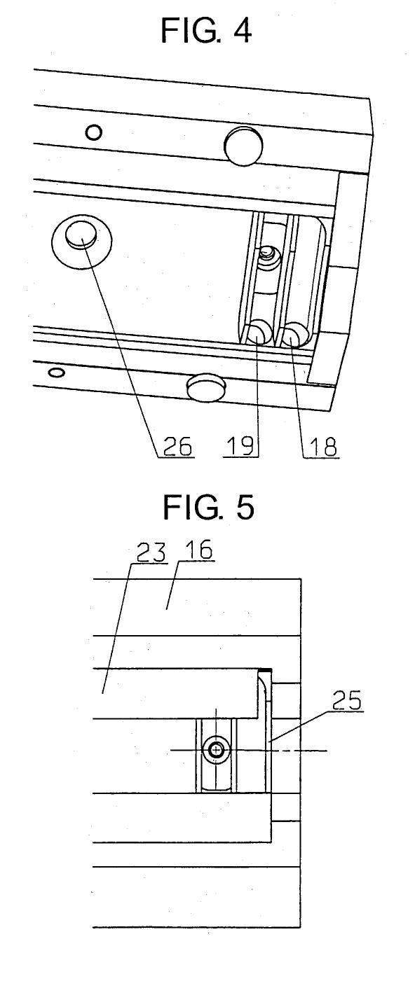

FIG. 4 Another isometric view of an end of the doctor blade chamber from a slightly different viewing angle, whereby the doctor blades and their support rails are also not illustrated

FIG. 5 A top view of the doctor blade chamber with support rails and doctor blades, whereby only the elements in the proximity of the end of the doctor blade chamber are shown

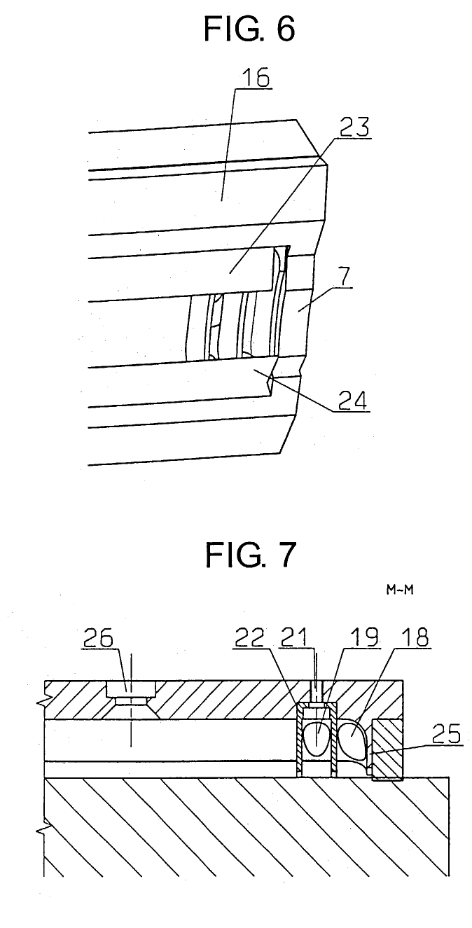

FIG. 6 An isometric view of the characteristics shown in FIG. 5

FIG. 7 A section along the line M-M, whereby the doctor blades and their support rails are not illustrated either.

FIG. 1a shows a section through an embodiment example of the invention. This figure clearly shows that the anilox roll 2, which during its operation rotates around the axis D in the direction of the curved arrow 3, the ink chamber body 4, as well as the locking 23 and working doctor blade 24, limit the ink chamber 1. Further it is shown in which way both doctor blades are retained by the support rails 16. FIG. 1b shows a top view of the doctor blade chamber 1 with a disavowed anilox roll 2. In addition to the elements shown in the other figures, the positions of the sections N-N and M-M, as well as the bores 26 for the fastening screws of the doctor blade chamber are illustrated. FIGS. 2 to 4 show views of the embodiment example mentioned, whereby the doctor blades and their support rails are not illustrated. These support rails are attached to the doctor blade chamber body 4 by means of the fastening elements 6. The end cover of the doctor blade chamber is achieved with the aid of the seal 7. This seal is produced of a flexible material in the embodiment example. The seal 7 has a clamping plate that is not illustrated, as the end stop unit. This clamping plate is locked on the doctor blade chamber body 4 by means of screws (also not illustrated), which engage into the threaded bores 17. In this regard, the seal 7 is usually locked between the stud of the doctor blade chamber body 25 and the clamping plate. Between the seal and the dye zone 14 of the anilox roll are the two intermediate walls 11 and 13, which define the first and the second chambers 9 and 10.

It is obvious from this description that those sections of the anilox roll 2 are meant by dye zone 14, that are voluntarily dyed. In the device illustrated, this is the case in the areas of the anilox roll 2 that are central in axial direction, which are located between both second intermediate walls 13. The dyeing of the anilox roll in the area of the chambers 9, 10, which is absolutely possible, and the seal 7 in the edge areas of the dye roll occurs involuntarily.

For production technological reasons, both intermediate walls 11, 13 are part of a one-piece intermediate wall body 22 in the example shown, which is attached to the doctor blade chamber body 4 by means of a fastening screw (not illustrated). This fastening screw is screwed into the threaded bore 21. Ink or ink residue that reached the two chambers is discharged through the bores 18 and 19, which have the function of a drain. Of course, such a bore can also be embodied so that it takes on a drain function for several chambers at the same time. This is the case, for instance, when one intermediate wall 11 extends centrally across a bore, and the bore has a diameter that is larger than the thickness of the intermediate wall.

FIGS. 5 to 7 show the embodiment example including the doctor blades and the support rails. The locking doctor blade 23 already ends, as mentioned, in the first chamber 9. Therefore, the doctor blade chamber 1 shown should not be tilted toward the locking doctor blade.

The difference mentioned several times to the FIGS. 2 to 4 already described exists in the illustration shown here of the support rails for the doctor blades 16. FIG. 7 further shows essential characteristics of the invention in a section.

The discharge bores 18, 19, the one-piece intermediate wall body 22, and the seal 7 are clearly illustrated. Furthermore it is shown in which way the seal 7 is attached between the stud 26 of the doctor blade chamber body 4 and the not illustrated clamping area, which was mentioned in the description of the first embodiment example.

In both embodiment examples shown, merely one second intermediate wall was inserted. However, it is also possible, and in accordance with the invention, to insert additional intermediate walls. It should also be mentioned that ink supply lines are present in the central area of the ink chamber 1, which were not illustrated in the figures.

Reference Symbol Table

| 1 | ink chamber |
|---|---|
| 2 | ink roll |
| 3 | curved arrow in rotation direction of roll |
| 4 | ink chamber body |
| 5 | doctor blade |
| 6 | fastening elements of the doctor blades |
| 7 | seal/sealing element |
| 8 | sealing surface |
| 9 | 1^{st} chamber |
| 10 | 2^{nd} chamber |
| 11 | 1^{st} intermediate wall |
| 12 | fastening element |
| 13 | 2^{nd} intermediate wall |
| 14 | dye zone |
| 15 | viewing direction of figures 2 to 7 |
| 16 | support rails for doctor blades |
| 17 | bores for fastening screws of the clamping plate |
| 18 | bores for the bleeding of the first chamber/ink discharge |
| 19 | bores for the bleeding of the first chamber/ink discharge |
| 20 | fastening screw for the one-piece intermediate wall body |
| 21 | bore for the fastening screw for the one-piece |
| | intermediate wall body |
| 22 | one-piece intermediate wall body |
| 23 | locking doctor blade |
| 24 | working doctor blade |
| 25 | stud of doctor blade chamber body |
| 26 | bore for the fastening screw of the doctor blade chamber body |
| D | Axis of the roll movement |

1. Ink chamber (1) for rotation printing machines,
which is comprised of at least the following elements:
an anilox roll (2) that rotates around an axis (D) during operation,
an elongated doctor blade chamber body (4) that limits the ink chamber (1) at least on the side opposite of the ink roll (2),
at least one supply line, through which ink reaches the interior of the ink chamber,
two wedge-like doctor blades (23, 24) that can be set to the ink roll,
two sealing bodies (7) that limit the ends of the ink chamber (1), whereby the sealing surfaces of the sealing bodies are set against the ink roll (2),
two first intermediate walls (11), of which one each is arranged between the dye zone (14) of the ink roll and the respective sealing body so that first chambers (9) are created on each side of the doctor blade chamber between the sealing bodies (7) and the intermediate walls (11),
at least two ink discharges (18) that discharge ink from the first chambers (9)
characterized in that
at least one additional intermediate wall (13) is provided between the dye zone (14) of the ink roll (2) and the first intermediate walls (11) so that at least one additional chamber (10) is created between the first (11) and the additional intermediate walls (13).

2. Ink chamber according to claim 1
characterized in that
at least one doctor blade (23, 24) end already between an intermediate wall (11, 13) and the seal (7) on at least one end of the ink chamber (1).

3. Ink chamber according to claim 2
characterized in that
the locking doctor blade (23) ends already between an intermediate wall (13) and the seal (7).

4. Ink chamber according to claims 2 or 3
characterized in that
at least the one doctor blade (24) ends in the first chamber (9).

5. Ink chamber according to one of the previous claims
characterized in that
at least one ink discharge (19) is provided in at least one additional chamber (10), through which ink is discharged from the additional chamber.

6. Ink chamber according to one of the previous claims
characterized in that
at least part of the ink is discharged from the chambers (9, 10) by means of gravity.

7. Ink chamber according to one of the previous claims
characterized in that
at least one one-piece intermediate wall body 22 is used, which is comprised of at least two intermediate walls (11, 13).
